(19) United States
(12) Patent Application Publication
(10) Pub. No.: US 2006/0123717 A1
(43) Pub. Date: Jun. 15, 2006

(54) Hurricane Hanger

(76) Inventor: Glenn Lawrence Huminski, Sarasota, FL (US)

Correspondence Address: GLENN LAWRENCE HUMINSKI, 4463 WHITE EGRET LANE, SARASOTA, FL, 34238, US

(21) Appl. No.: 11/000,469

(22) Filed: Nov. 30, 2004

(51) Int. Cl. E06B 3/26

(52) U.S. Cl. 52/202

(57) ABSTRACT

What is new to the art to which this technical disclosure pertains, is that once the fasteners are initially installed to the bracket and building, an individual has the ability to install and remove the hurricane hanger shutter assembly without the necessity to install or remove additional fasteners, in a manner which allows the user to slip the shutter in place, securing it in a locked position, without tools or expertise.

### CROSS REFERENCE TO RELATED APPLICATIONS

Not Applicable

### STATEMENT REGARDING FEDERALLY SPONSORED RESEARCH OR DEVELOPMENT

Not Applicable

### RERERENCE TO SEQUENCE LISTING, A TABLE, OR A COMPUTER PROGRAM LISTING COMPACT DISK APPENDIX

Not Applicable

### BACKGROUND OF THE INVENTION

The hurricane hanger is a piece of hardware that is designed to attach to a panel (plywood, fiberglass or other) which allows this newly created hurricane shutter to be mounted to building, without installing the fasteners upon each use.

Prior to the invention, the state of the art was such that a building owner or tenant would try to attach a panel to the building by drilling a hole in the panel and then securing a screw through the panel into the building. This was often done as a hurricane approached when high winds begin. The associated problems with this process are that: 1) Due to the cumbersome size and weight of the panel it is impossible for a single person to lift and hold a sheet of plywood in position by themselves and drill into the building and then secure the fastener. More than one person was necessary. 2) After the storm passed, in order to remove the panel the fastener must be removed, again requiring more than one person to support the size and weight of the panel. 3) Once this step of removing the panel was completed, holes were left in the building which then made the building susceptible to water infiltration via rain, bugs entering the building through these holes, and potential energy loss. The solution would be to fill the holes and then apply matching paint.

When another hurricane approached, with the exception of drilling holes into the panel, the above steps would need to be repeated, again requiring more than one person to accomplish the task.

If more than one person was not available to install shutters, the building and the people inside were often left unprotected from projectiles impacting through the windows and or doors causing damage and potential injury.

### BRIEF SUMMARY OF THE INVENTION

This invention allows users to permanently mount screws/fasteners to buildings that are designed to fit into slots on a bracket called the Hurricane Hanger. The Hurricane Hanger permanently attaches to a panel (plywood, fiberglass or other) creating a hurricane shutter which can then be freely installed and removed repeatedly by a single person without installing or removing screws/fasteners a second time. This invention allows the creation of a do-it-yourself hurricane shutter at a minimal cost which will protect people and their property.

### BRIEF DESCRIPTION OF THE SEVERAL VIEWS OF THE DRAWING

FIG. 1A) Front View. This drawing depicts the design of the bracket including the holes used to permanently mount the bracket to the panel with nuts and bolts as well as the slots which engage with the screws which are permanently mounted above or around the window or door. Two aspects of the slots are shown. The elliptical (football shaped) bottom of the slot is the resting position for the window/door screw's head when engaged with the hurricane hanger which allows for the bracket to be easily located over the screw head and also supports the weight of the shutter. The top of the long, thin vertical slot is the locked position of when the window/doors screw's head is engaged with the hurricane hanger. The diameter of the window/door screw head is wider than the diameter of the long, thin vertical slot thus locking it in place.

FIG. 1B) Side View. This drawing depicts the side profile of the hurricane hanger, shaped like the lower case letter “h”, with the panel (plywood) permanently attached with the nuts and bolts. It also shows the permanently mounted screw located above and into the window or door soffit. This screw shall be set at a predetermined dimension as measured from the face of the soffit to the back of the screw head. The top of the “h” is gradually thicker than the middle section of the “h”. The dimension from the face of the soffit to the back of this screw head shall be less than the thickness of the bracket at the top of the letter “h”. This thicker area acts as a compression fitting when engaged with the permanently mounted screw head at the locked position. Note: For ease of clarity, the compression fit feature does not show the bracket being flush up against the face of the soffit nor does it show the tightening of the thicker portion of the upper bracket against the back of the screw head. In an actual installation, these areas would be compressed together forming a locked position.

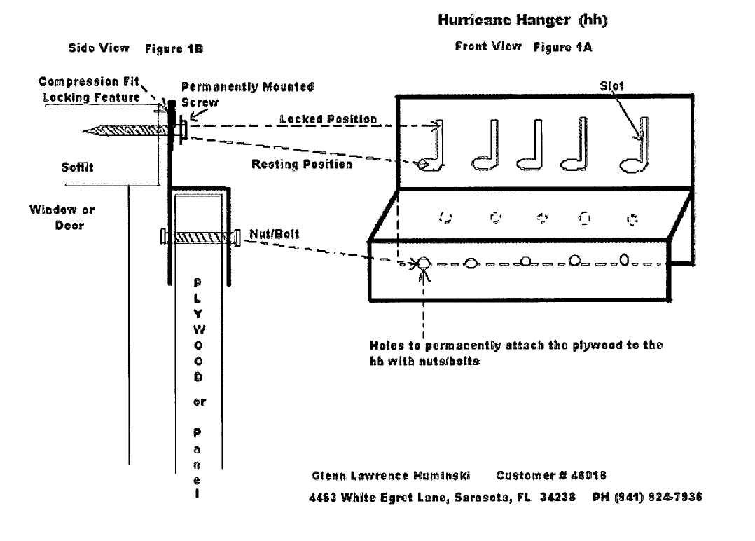

### DETAILED DESCRIPTION OF THE INVENTION

The Hurricane Hanger is a bracket when combined with a fastening system creates a hurricane shutter. The bracket is made of aluminum, steel, or any metal, high impact plastic, fiberglass reinforced polyester (FRP) or any similar high strength material. The bracket will be manufactured by extruding one of the above listed materials. The purpose of the bracket is to permanently fasten to a panel which may be made of plywood, fiberglass, FRP, plastic, or any other high strength or similarly shaped material. When these two components are permanently attached to each other, they create a do-it-yourself hurricane shutter, which can then be secured to a building over the windows and or doors which prevent a projectile from impacting these areas thus protecting people and property. This design allows for the repeated installation and removal of the hurricane shutter by a single person.

The side view of the bracket is shaped like the lower case letter “h”. The bracket is four feet long (to accommodate the width of a standard 4′×8′ sheet of plywood), approximately 1″ wide at the lower base of the letter “h” (to accommodate varying thicknesses of plywood), and approximately 5″ high. The panel which creates the shutter, fits into the pocket of the “h” shaped bracket, and is secured by a series of nuts and bolts which fit into the holes drilled through the front and back of the ‘h” pocket. The hurricane hanger bracket can be cut to different lengths at the time of installation in order to accommodate different sized panels.

Separately, a series of screws, tap-cons, nails, or other high strength fasteners are drilled or secured to the building over or around the windows and doors on which the bracket and panel assembly will engage and secure itself to. The location and spacing of the fasteners will correspond to spacing and design of slots which are formed into the upper portion of the letter “h”. These slots are comprised of two adjoining shapes which serve different functions. The bottom of the slot is elliptical (football shaped) in nature and is larger than the screw head which is secured over the window or door. This oversized elliptical shape allows for the bracket and panel assembly to be easily located and placed over the screw head. The full weight of the assembly is then supported in this “resting position”. Once in the resting position, a lateral movement is necessary to cause the assembly to slide over and drop downward so that the head of the permanently mounted window or door screw comes to rest at the top of the long, thin vertical slot. As this screw head rises to the top of the slot, this thicker area of the top of the “h” causes the screw head to tighten against the hurricane hanger bracket thus creating a compression fit. Because the screw head is wider in diameter versus the vertical slot, combined with this compression fit, the hurricane hanger is now engaged in the “locked position”.

In order to remove the hurricane hanger assembly, a lifting motion and an opposite lateral movement will be required. The placement and removal of the hurricane shutter can be accomplished many times over without damaging the building.

An additional benefit to this system is that the hurricane hanger bracket increases the size and strength of the panel which provides a greater degree of protection to the doors or windows. Because the hurricane shutter is mounted to the soffit, completely surrounding but away from the window or door frame, water infiltration is minimized. Also, because of this installation method, the shutter will not press against the window or door. If it did, broken glass could result simply from the pressure of the panel against the glass during wind gusts.

1) What I claim as my invention is a bracket that can be permanently mounted to a sheet of plywood or other similar material (herein after “panel”) to be used as a hurricane shutter to be placed over windows, doors and other openings in case of a hurricane or other severe storm.

2) What I claim as my invention is the design of the bracket, which will be four feet long, and about five inches high, the side view which will resemble a lower case letter “h” and a series of elliptical holes and adjoining thin vertical slots that will be drilled into the upper portion of the bracket.

3) What I claim as my invention is the design of the placement of the holes of the bracket coinciding with a series of fasteners attached to a building alongside the frame of a door, window or other opening, upon which the attached fasteners can be placed inside the holes and the bracket attached thereupon.

4) What I claim as my invention is the design of the bracket itself, which will become gradually thicker at the top, such that when the bracket is slid over the existing fastener, a compression fit is formed at the top of the vertical slot, locking it into place.

5) What I claim as my invention is the design of the holes (slots) of the bracket, which will be elliptical in nature at the bottom with an adjoining thin vertical slot extending from the lower end of the elliptical hole at an angle of 90 degrees upward, causing the head of the fastener when inserted into the elliptical shaped hole, to be at a resting position with the panel's weight supported, and requiring a secondary lateral movement which will bring the fastener head to the top of the thin vertical hole, locking it into place as it compresses against the thicker portion of the bracket.

6) What I claim as my invention is a bracket that can be permanently attached to a panel, so that it can serve as a hurricane shutter by fitting into a series of screws fastened to the frame of a window, door or other opening and can be attached or removed by one person without assistance of another person and without tools.
